(19) United States
(12) Patent Application Publication
(10) Pub. No.: US 2007/0297193 A1
(43) Pub. Date: Dec. 27, 2007

(54) Light guiding board and light source and display panel unit and electronic apparatus

(75) Inventors: Yasuhiro Ite, Kawasaki (JP); Chikara Nishio, Kawasaki (JP); Masaru Sugie, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/895,992

(22) Filed: Aug. 27, 2007

Related U.S. Application Data
(63) Continuation of application No. PCT/JP05/05028, filed on Mar. 18, 2005.

(51) Int. Cl. F21V 7/04

(52) U.S. Cl. 362/615

(57) ABSTRACT

A light guiding board allows introduction of light into an optically-transparent board member through an incidence surface. Prisms serve to irradiate the light out of the back surface of the optically-transparent board member. A surface emission is realized at the back surface of the optically-transparent board member. In the case where an uneven luminance is generated in the light emitted toward the incidence surface, a flat region is aligned with a dark region. The flat region serves to direct the light to the prisms. The light scatters at a position outside the flat region based on the action of a light scattering structure. A part of the scattered light is directed to the extension of the flat region. The light of a sufficient amount can be introduced into the prisms on the extension of the flat region.

This is a continuation filed under 35 U.S.C. §111(a), of International Application No. PCT/JP2005/005028, filed Mar. 18, 2005.

### BACKGROUND OF THE INVENTION

1. Field of the Invention

The present invention relates to an electronic apparatus such as a cellular phone terminal. In particular, the present invention relates to a light guiding board, a light source unit and a display panel unit, incorporated in the electronic apparatus.

2. Description of the Prior Art

A cellular phone terminal includes a liquid crystal display (LCD) panel unit providing a screen. The LCD panel unit of a so-called front light type includes a light guiding board opposed to the surface of a LCD panel. Parallel prisms are formed on the surface of the light guiding board. A light guiding member is opposed to the end surface of the light guiding board. A pair of light sources is respectively opposed to the side surfaces of the light guiding member, for example.

The light guiding member serves to direct light emitted from the light sources into the light guiding board. The prisms of the light guiding board serve to direct the light toward the LCD panel. A reflector is attached to the back surface of the LCD panel. The reflector serves to radiate the light out of the cellular phone terminal. Various texts and graphics are in this manner displayed on the screen.

A so-called dark line is established on the light guiding board in the cellular phone terminal. The dark line results from machining errors of the light guiding member. The dark line leads to generation of an uneven luminance across the screen of the LCD panel. Since the light guiding board is placed between the LCD panel and the eyes of a user particularly in the LCD panel unit of the front light type, such an uneven luminance really needs to be prevented.

### SUMMARY OF THE INVENTION

It is accordingly an object of the present invention to provide a light guiding board, a light source unit, a display panel unit and an electronic apparatus, capable of realizing a highly uniform luminance distribution.

According to a first aspect of the present invention, there is provided a light guiding board comprising: an incidence surface defined in the end surface of an optically-transparent board member; parallel prisms formed on the surface of the optically-transparent board member at a position distanced from the incidence surface; a flat region defined along a straight line in the surface of the optically-transparent board member between the incidence surface and the parallel prisms; and a light scattering structure placed between the incidence surface and the parallel prisms, the light scattering structure formed on the surface of the optically-transparent board member at a position off the flat region, the light scattering structure having a boundary surface designed to scatter light.

The light guiding board allows introduction of light into the optically-transparent board member through the incidence surface. The prisms serve to irradiate the introduced light out of the back surface of the optically-transparent board member. A surface emission is realized at the back surface of the optically-transparent board member in this manner. In the case where an uneven luminance is generated in the light emitted toward the incidence surface, the flat region is aligned with a dark region. The flat region serves to reflect the light for directing the light to the prisms. Simultaneously, the light scatters at a position outside the flat region based on the action of the light scattering structure. A part of the scattered light is directed to the extension of the flat region. The light of a sufficient amount can be introduced into the prisms on the extension of the flat region. This results in prevention of generation of a dark line on the light guiding board. Generation of a so-called uneven luminance is prevented. The light guiding board is allowed to enjoy a highly uniform luminance distribution.

The light scattering structure may include a polishing mark in the light guiding board. Sandpaper may be utilized to form the polishing mark, for example. Alternatively, the light scattering structure may include a curved prism designed to extend toward the flat region along a curved line. Otherwise, the light scattering structure may include a protrusion protruding from the surface of the optically-transparent board member. The polishing mark, the curved prism and the protrusion serve to scatter light in the light guiding board.

A light guiding board according to another example may allow the light scattering structure to include: the light scattering structure includes: a first protrusion protruding from the surface of the optically-transparent board member at a position distanced from the flat region by a first distance; and a second protrusion protruding from the surface of the optically-transparent board member at a position distanced from the flat region by a second distance larger than the first distance. In this case, the boundary surface defined between the first protrusion and the optically-transparent board member may be set larger in the direction perpendicularly intersecting the straight line than the boundary surface defined between the second protrusion and the optically-transparent board member. The first and second protrusions serve to scatter the light introduced through the incidence surface in the light guiding board. Since the first protrusion is set larger in the direction perpendicular to the straight line than the second protrusion, the first protrusion serves to scatter the light widely along the surface of the light guiding board as compared with the light scattered at the second protrusion. In addition, the first protrusion is placed at a position distanced from the flat region by the first distance smaller than the second distance. The first protrusion thus serves to direct a part of the scattered light to the extension of the flat region in a relatively large amount as compared with the light scattered at the second protrusion. The light guiding board in this manner realizes a highly uniform luminance distribution. This type of the light guiding board is particularly useful in the case where a relatively larger difference is established in the amount of the light between the flat region and an area closer to the flat region outside the flat region, for example.

A light guiding board according to another example may allow the light scattering structure to include: a first protrusion protruding from the surface of the optically-transparent board member at a position distanced from the flat region by a first distance; and a second protrusion protruding from the surface of the optically-transparent board member at a position distanced from the flat region by a second distance larger than the first distance, in the same manner as described above. In this case, the boundary surface defined between the first protrusion and the optically-transparent board member is set smaller in the direction perpendicular to the straight line than the boundary surface defined between the second protrusion and the optically-transparent board member. Since the first protrusion is set smaller in the direction perpendicular to the straight line than the second protrusion, the first protrusion scatters the light narrowly along the surface of the light guiding board as compared with the light scattered at the second protrusion. The first protrusion is placed at a position distanced from the flat region by the first distance smaller than the second distance. The first protrusion thus serves to direct a part of the scattered light to the extension of the flat region. On the other hand, the second protrusion serves to scatter the light widely along the surface of the light guiding board as compared with the first protrusion. Though the second protrusion is placed at a position distanced from the flat region by the second distance larger than the first distance, the second protrusion serves to direct a part of the scattered light to the extension of the flat region in a relatively large amount. The light guiding board allows establishment of a highly uniform luminance distribution. This type of the light guiding board is particularly useful in the case where a relatively larger difference is established in the amount of the light between the flat region and an area remoter from the flat region outside the flat region, for example.

The area of the boundary surface defined between the optically-transparent board member and the first protrusion may be set larger than the area of the boundary surface defined between the optically-transparent board member and the second protrusion in the light scattering structure including the first and second protrusions. The first and second protrusions serve to scatter the light introduced through the incidence surface in the light guiding board. Since the area of the boundary surface of the first protrusion is set larger than the area of the boundary surface of the second protrusion, the first protrusion serves to scatter the light widely along the surface of the light guiding board as compared with the light scattered at the second protrusion. In addition, the first protrusion is placed at a position distanced from the flat region by the first distance smaller than the second distance. The first protrusion thus serves to direct a part of the scattered light to the extension of the flat region in a relatively large amount as compared with the light scattered at the second protrusion. The light guiding board in this manner realizes a highly uniform luminance distribution. This type of the light guiding board is particularly useful in the case where a relatively larger difference is established between the flat region and an area closer to the flat region outside the flat region, for example.

The area of the boundary surface defined between the optically-transparent board member the first protrusion may be set smaller than the area of the boundary surface defined between the optically-transparent board member and the second protrusion, in the light scattering structure including the first and second protrusions. The first protrusion serves to scatter the light narrowly along the surface of the light guiding board as compared with the light scattered from the second protrusion in the same manner as described above. The first protrusion is placed at a position distanced from the flat region by the first distance smaller than the second distance, so that the first protrusion serves to direct a part of the scattered light to the extension of the linear region. Likewise, the second protrusion serves to scatter the light widely along the surface of the light guiding board as compared with the light scattered at the first protrusion. Though the second protrusion is placed at a position distanced from the flat region by the second distance larger than the first distance, the second protrusion serves to direct a part of the scattered light to the extension of the linear region in a relatively large amount. The light guiding board thus realizes a highly uniform luminance distribution. This type of the light guiding board is particularly useful in the case where a relatively larger difference is established in the amount of the light between the flat region and an area remoter from the flat region outside the flat region, for example.

The shape of the boundary surface defined between the first protrusion and the optically-transparent board member may be set identical to the shape of the boundary surface defined between the second protrusion and the optically-transparent board member in the light scattering structure including the first and second protrusions. The first and second protrusions may each define a reference line extending within the boundary surface. The reference line may be unique to the shape of the boundary surfaces. In this case, the intersection angle between the reference line of the first protrusion and the straight line is set larger than the intersection angle between the reference line of the second protrusion and the straight line. The first protrusion serves to scatter the light widely along the surface of the light guiding board toward the extension of the linear region. In addition, the first protrusion is placed at a position distanced from the flat region by the first distance smaller than the second distance. The first protrusion thus serves to direct a part of the scattered light to the extension of the flat region in a relatively large amount as compared with the light scattered at the second protrusion. The light guiding board is thus allowed to realize a highly uniform luminance distribution in the same manner as described above.

A light guiding board according to another example may allow the light guiding structure to include: a first protrusion group consisting of protrusions protruding from the surface of the optically-transparent board member at a position distanced from the flat region by a first distance; and a second protrusion group consisting of protrusions protruding from the surface of the optically-transparent board member at a position distanced from the flat region by a second distance larger than the first distance. The protrusions of the first protrusion group may be arranged at a higher density than the protrusions of the second protrusion group. In addition, the first protrusion group is placed at a position distanced from the flat region by the first distance smaller than the second distance. The first protrusion group is thus allowed to scatter the light of a larger amount as compared with the second protrusion group. The first protrusion group thus serves to direct a part of the scattered light to the extension of the flat region in a larger amount as compared with the light scattered at the second protrusion group. The light guiding board in this manner realizes a highly uniform luminance distribution in the same manner as described above.

According to a second aspect of the present invention, there is provided a light guiding board comprising: an incidence surface defined in the end surface of an optically-transparent board member; parallel prisms formed on the surface of the optically-transparent board member at a position distanced from the incidence surface; a flat region defined along a straight line in the surface of the optically-transparent board member between the incidence surface and the parallel prisms; and spherical members placed on the surface of the optically-transparent board member between the incidence surface and the parallel prisms at positions off the flat region so as to scatter light. The spherical members serve to scatter the light introduced through the incidence surface. The light guiding board thus realizes a highly uniform luminance distribution in the same manner as described above.

The light guiding board may be incorporated in a light source unit, for example. The light source unit may comprise: a light source; a light guiding member designed to reflect light emitted from the light source so as to irradiate the light from an output surface defined on the light guiding member; an optically-transparent board member opposed to the light guiding member; an incidence surface defined in the end surface of the optically-transparent board member, the incidence surface opposed to the output surface of the light guiding member; parallel prisms formed on the surface, of the optically-transparent board member at a position distanced from the incidence surface so as to reflect the light output from the light guiding member; a flat region defined along a straight line in the surface of the optically-transparent board member between the incidence surface and the parallel prisms; and a light scattering structure formed on the surface of the optically-transparent board member between the incidence surface and the parallel prisms at a position of f the flat region, the light scattering structure having a boundary surface designed to scatter light.

The light source unit allows the light guiding member to irradiate the light from the output surface. The light is then introduced into the optically-transparent board member through the incidence surface. The prisms serve to output the introduced light from the back surface of the optically-transparent board member. A surface emission is realized at the back surface of the optically-transparent board member in this manner. In the case where an uneven luminance is generated in the light emitted from the output surface based on machining errors of the light guiding member, the flat region is aligned with a dark region. The flat region serves to reflect the light toward the prisms. Simultaneously, the light scattering structure serves to scatter the light at a position outside the flat region. A part of the scattered light can be directed to the extension of the flat region. The light of a sufficient amount can thus be led to the extension of the flat region. This results in prevention of generation of a dark line on the light guiding board. The light guiding board is thus prevented from suffering from generation of a so-called uneven luminance. The light guiding board in this manner realizes a highly uniform luminance distribution.

Likewise, the light guiding board may be incorporated in a display panel unit such as a liquid crystal display (LCD) panel unit. In this case, the display panel unit may comprise: a light source; a light guiding member designed to reflect light emitted from the light source so as to irradiate the light from an output surface defined on the light guiding member; an optically-transparent board member opposed to the light guiding member; an incidence surface defined in the end surface of the optically-transparent board member, the incidence surface opposed to the output surface of the light guiding member; parallel prisms formed on the surface of the optically-transparent board member at a position distanced from the incidence surface so as to reflect the light output from the light guiding member; a flat region defined along a straight line in the surface of the optically-transparent board member between the incidence surface and the parallel prisms; a light scattering structure formed on the surface of the optically-transparent board member between the incidence surface and the parallel prisms at a position off the flat region, the light scattering structure having a boundary surface designed to scatter light; and a display panel opposed to the surface of the optically-transparent board member. The display panel unit is in this manner allowed to enjoy a highly uniform luminance distribution in the same manner as described above.

Likewise, the light guiding board may be incorporated in an electronic apparatus such as a cellular phone terminal. In this case, the electronic apparatus may comprise: an enclosure; a light source incorporated in the enclosure; a light guiding member designed to reflect light emitted from the light source so as to irradiate the light from an output surface defined on the light guiding member; an optically-transparent board member opposed to the light guiding member; an incidence surface defined in the end surface of the optically-transparent board member, the incidence surface opposed to the output surface of the light guiding member; parallel prisms formed on the surface of the optically-transparent board member at a position distanced from the incidence surface so as to reflect the light output from the light guiding member; a flat region defined along a straight line in the surface of the optically-transparent board member between the incidence surface and the parallel prisms; a light scattering structure formed on the surface of the optically-transparent board member between the incidence surface and the parallel prisms at a position off the flat region, the light scattering structure having a boundary surface designed to scatter light; and a display panel opposed to the surface of the optically-transparent board member, the display panel exposed in an opening defined in the enclosure. The electronic apparatus is in this manner allowed to enjoy a highly uniform luminance distribution in the screen exposed in the opening of the enclosure in the same manner as described above.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a perspective view schematically illustrating a cellular phone terminal as an example of an electronic apparatus according to an embodiment of the present invention;

FIG. 2 is an exploded perspective view schematically illustrating an LCD panel unit according to the present invention;

FIG. 3 is a partial plan view schematically illustrating the LCD panel unit;

FIG. 4 is a sectional view taken along the line 4-4 in FIG. 3 for schematically illustrating the LCD panel unit;

FIG. 5 is a graph showing luminance distribution in an LCD panel unit according to a comparative example;

FIG. 6 is a graph showing luminance distribution in an LCD panel unit according to a specific example;

FIG. 7 is a sectional view, corresponding to FIG. 4, for illustrating a light scattering structure;

FIG. 8 is a partial plan view schematically illustrating a light guiding board according to a specific example;

FIG. 9 is a partial plan view schematically illustrating a light guiding board according to a modification of the specific example;

FIG. 10 is a partial plan view schematically illustrating a light guiding board according to another example of the modification;

FIG. 11 is a partial plan view schematically illustrating a light guiding board according to still another example of the modification;

FIG. 12 is a partial plan view schematically illustrating a light guiding board according to still another example of the modification;

FIG. 13 is a partial plan view schematically illustrating a light guiding board according to still another example of the modification;

FIG. 14 is a partial plan view schematically illustrating a light guiding board according to still another example of the modification;

FIG. 15 is a partial plan view schematically illustrating a light guiding board according to still another example of the modification; and

FIG. 16 is a partial plan view schematically illustrating a light guiding board according to still another example of the modification.

### DESCRIPTION OF THE PREFERRED EMBODIMENTS

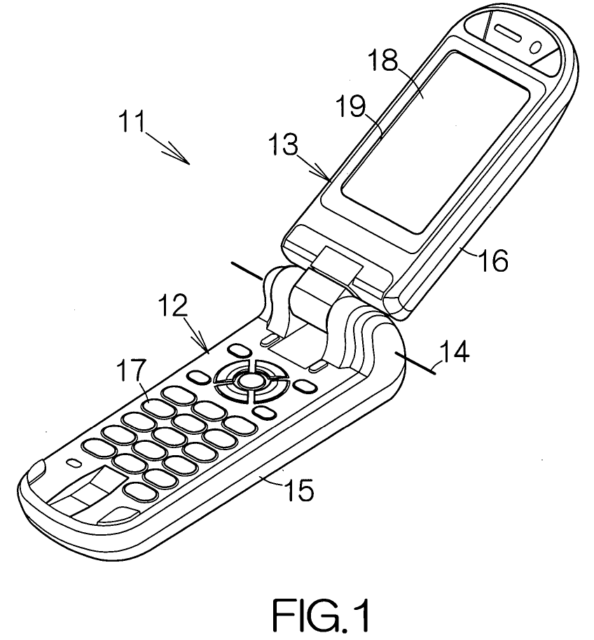

FIG. 1 schematically illustrates a cellular or mobile phone terminal 11 as an example of an electronic apparatus according to an embodiment of the present invention. The cellular phone terminal 11 includes a microphone-side unit 12 and a speaker-side unit 13. The speaker-side unit 13 is designed to rotate relative to the microphone-side unit 12 around a rotation axis 14. The microphone-side unit 12 has a main body enclosure 15 serving as a first enclosure. The speaker-side unit 13 has a display enclosure 16 serving as a second enclosure. The main body enclosure 15 and the display enclosure 16 may be molded from a reinforced resin material, for example.

A printed circuit board, not shown, is incorporated within the main body enclosure 15. Processing circuits, such as a central processing unit (CPU) and a memory, are mounted on the printed circuit board in a conventional manner. Input keypads 17, such as an on-hook keypad, an off-hook keypad, ten keypads, and the like, are embedded in the front surface of the microphone-side unit 12. The CPU operates in response to the manipulation of the input keypads 17.

A flat display panel unit such as a liquid crystal display (LCD) panel unit 18 is incorporated within the display enclosure 16. A window opening 19 is defined in the front surface of the display enclosure 16. The flat screen of the LCD panel unit 18 is placed within the window opening 19. Various texts and graphics are displayed on the screen of the LCD panel unit 18 in response to the operation of the CPU.

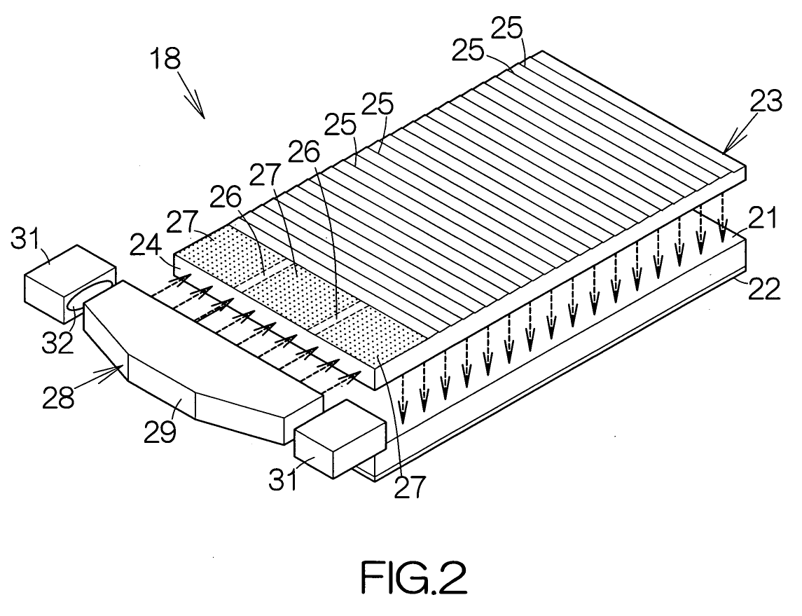

As shown in FIG. 2, the LCD panel unit 18 has the structure of a so-called front light type. Specifically, the LCD panel unit 18 includes a LCD panel 21 in the shape of a rectangle. The LCD panel 21 includes liquid crystal cells between a pair of glass substrates, for example. Each liquid crystal cell corresponds to one pixel of the screen. The LCD panel 21 has the structure of a so-called reflection type. A reflector 22 is attached to the back surface of the glass substrate. A circuit board, not shown, may be placed on the back surface of the reflector 22 so as to control display, for example.

The LCD panel unit 18 includes a light guiding board 23 having a flat back surface opposed to the front surface of the LCD panel 21. The light guiding board 23 may be made of an optically-transparent board member in the shape of a rectangle. The light guiding board 23 defines four end surfaces perpendicular to the back surface of the light guiding board 23. Each end surface defines a flat surface. One of the end surfaces of the light guiding board 23 serves as an incidence surface 24.

Parallel prisms 25, 25, . . . are formed on the front surface of the light guiding board 23 at a position distanced from the incidence surface 24. The prisms 25 are each designed to extend on the front surface of the light guiding board 23 in parallel with the incidence surface 24. The prisms 25 are formed in a screen region defined in the LCD panel unit 18. The front surface of the light guiding board 23 at the screen region gets closer to the back surface of the light guiding board 23 as the distance gets farther from the incidence surface 24. The thickness of the light guiding board 23 at the screen region is thus gradually reduced as the distance gets farther from the incidence surface 34. The light guiding board 23 may be molded from a resin material such as plastic.

Flat regions 26 are defined in the surface of the light guiding board 23. The flat regions 26 are each designed to extend between the incidence surface 24 and the prisms 25 along a straight line. The flat regions 26 are placed outside the screen region of the LCD panel unit 18. The flat regions 26 each define a flat surface parallel to the back surface of the light guiding board 23. In this case, the straight line is designed to extend in the perpendicular direction perpendicularly intersecting the parallel prisms 25, for example. The flat regions 26 thus extend in the perpendicular direction perpendicularly intersecting the incidence surface 24.

A light scattering structure 27 is also formed on the surface of the light guiding board 23. The light scattering structure 27 is placed between the incidence surface 24 and the parallel prisms 25. The light scattering structure 27 includes a boundary surface enabling optical diffusion. The light scattering structure 27 is formed outside the flat regions 26. The light scattering structure 27 is placed outside the screen region in the same manner as the flat regions 26. The light scattering structure 27 includes fine polishing marks. The light scattering structure 27 thus serves to scatter light led through the incidence surface 24. The surface roughness Ra of the light scattering structure 27 may be set at approximately 0.08 μm, for example.

A light guiding member 28 is opposed to the incidence surface 24 of the light guiding board 23. An output surface is defined in the light guiding member 28 in parallel with the incidence surface 24 of the light guiding board 23 so as to face the light guiding board 23 at a distance. A reflection surface 29 is defined inside the light guiding member 28 so as to face the incidence surface 24 of the light guiding board 23 at a distance. Parallel prisms, not shown, are formed on the reflection surface 29. The parallel prisms extend in the perpendicular direction perpendicularly intersecting the back surface of the light guiding board 23. The prisms are arranged at minute intervals.

A pair of light sources 31, 31 are opposed to the side surfaces of the light guiding member 28, respectively. The light guiding member 28 is placed between the light sources 31, 31. A light-emitting diode (LED) 32 is incorporated in each of the light sources 31, for example. The LEDs 32 are opposed to the side surfaces of the light guiding member 28, respectively. The LEDs 32 are each designed to emit white light toward the side surface of the light guiding member 28, for example.

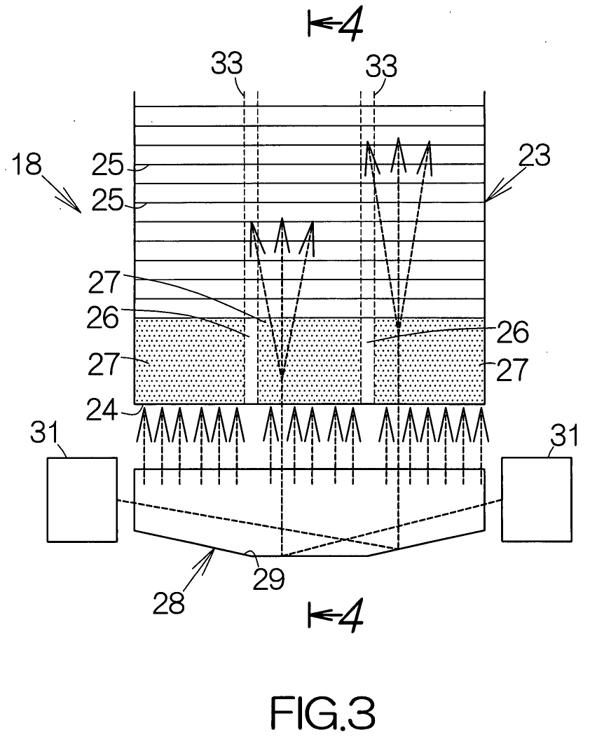

Now, assume that graphics are displayed on the screen of the LCD panel unit 18, for example. The LEDs 32 of the light sources 31 emit light into the light guiding member 28. The LEDs 32 serve as a so-called point source. As shown in FIG. 3, the prisms of the reflection surface 29 serve to direct the emitted light toward the incidence surface 24 of the light guiding board 23. The light guiding member 28 outputs the light from the output surface. The light guiding member 28 in this manner serves as a line source. In this case, the light guiding member 28 suffers from a reduction in the amount of the output light directed straight to the flat surfaces 26 from the output surface based on machining errors of the prisms on the reflection surface 29.

The light guiding board 23 allows the prisms 25 to direct the light, coming straight into the light guiding board 23 through the incidence surface 24, toward the surface of the LCD panel 21. Likewise, the prisms 25 serve to direct the light, coming into the light guiding board 23 at a predetermined incident angle, toward the surface of the LCD panel 21. The light guiding board 23 serves as a surface source. It should be noted that the LEDs 32 or light sources 31, the light guiding member 28 and the light guiding board 23 serve as a light source unit according to the present invention.

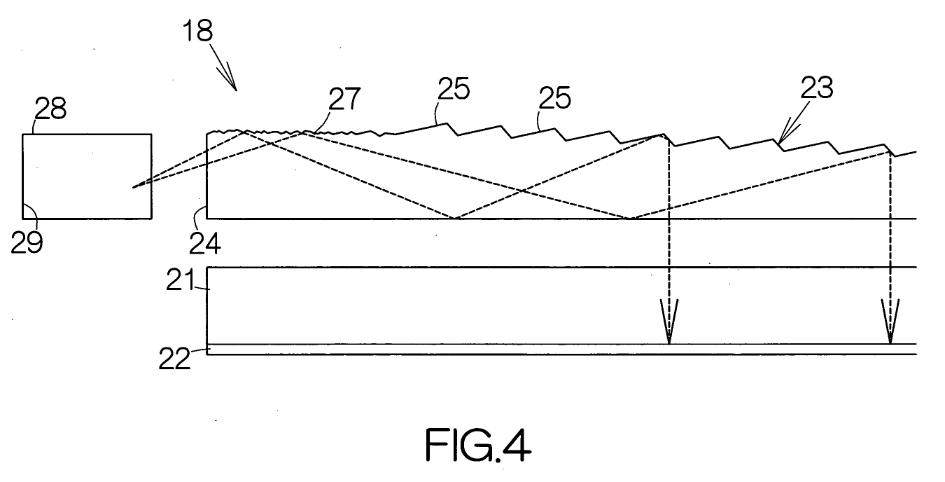

Referring also to FIG. 4, the light scattering structure 27 serves to scatter the light when the light reaches the light scattering structure 27. As is apparent from FIG. 3, the light is scattered along the surface of the light guiding board 23. The scattered light is directed to linear regions 33, 33 each extending from the flat region 26 in the perpendicular direction perpendicularly intersecting the parallel prisms 25. The prisms 25 then serve to direct the light to the surface of the LCD panel 21.

The output light from the light guiding board 23 penetrates through the LCD panel 21. The reflector 22 reflects the light. The reflected light passes through the light guiding board 23. The light is then emitted outward through the window opening 19. The liquid crystal cells and a color filter of the LCD panel 21 serve to display graphics on the screen of the LCD panel unit 18.

An uneven luminance of the emitted light is induced based on machining errors of the prisms on the reflection surface 29 in the cellular phone terminal 11 as described above. The flat regions 26 are aligned with dark regions. The light can thus be led to the prisms 25 while the light is reflected on the flat regions 26. Simultaneously, the light scattering structure 27 serves to scatter the light at a position off the flat regions 26. The scattered light partly reaches the linear regions 33. The light of a sufficient amount can thus be led to the prisms 25 in the linear regions 33. The amount of the light can be increased at the linear regions 33. This results in prevention of generation of a dark line on the light guiding board 23. An uneven luminance can be prevented. The LCD panel unit 18 is allowed to enjoy a uniform luminance distribution on the screen.

Filing process may be applied to the region outside the flat regions 26 to make the light guiding board 23. Sandpaper may be utilized in the filing process, for example. The positions of the flat regions 26 are determined on the light guiding board 23 prior to the filing process. The light guiding member 28 is prepared for the determination of the positions of the flat regions 26. The output light from the light guiding member 28 is observed. The flat regions 26 are set at positions irradiated with the output light of a small amount. Alternatively, simulation may be utilized to observe the output light from the light guiding member 28. In general, the accuracy of the prisms of the reflection surface 29 serves to determine the characteristic of the light output from the light guiding member 28. The accuracy of the prisms depends on the accuracy of the mold utilized to make the light guiding member 28. As long as the same mold is utilized, the light guiding members 28 are expected to have the output light of the same characteristic.

The inventors have observed the effects of the LCD panel unit 18. An example of the invention and a comparative example were prepared for the observation. The aforementioned flat regions 26 and light scattering structure 27 were formed on the light guiding board 23 in the LCD panel unit 18 according to the example of the invention. The flat regions 26 were set at areas irradiated with the output light of a small amount. The formation of the flat regions and light scattering structure was omitted in a LCD panel unit according to the comparative example. Otherwise, the LCD panel unit of the comparative example had the structure identical to that of the LCD panel unit according to the example of the invention. In this case, a light guiding board of 2 inches type was utilized both in the example of the invention and the comparative example. Luminance was measured in the example of the invention and the comparative example. The luminance was measured on a straight line spaced from the incidence surface 24 by a predetermined distance within the screen region. The straight line is set parallel to the prisms 25. A luminance meter was utilized for the measurement.

As shown in FIG. 5, it was observed that the luminance significantly changed depending on a position in the lateral direction of the light guiding board in parallel with the prisms in the LCD panel unit according to the comparative example. It has been confirmed that a so-called dark line is generated at positions respectively distanced from the end surfaces of the light guiding board by 10 nm approximately, for example. An area outside the dark line provides a relatively higher luminance than the luminance of the dark lines. It was observed that an uneven luminance was caused across the screen of the LCD panel unit according to the comparative example.

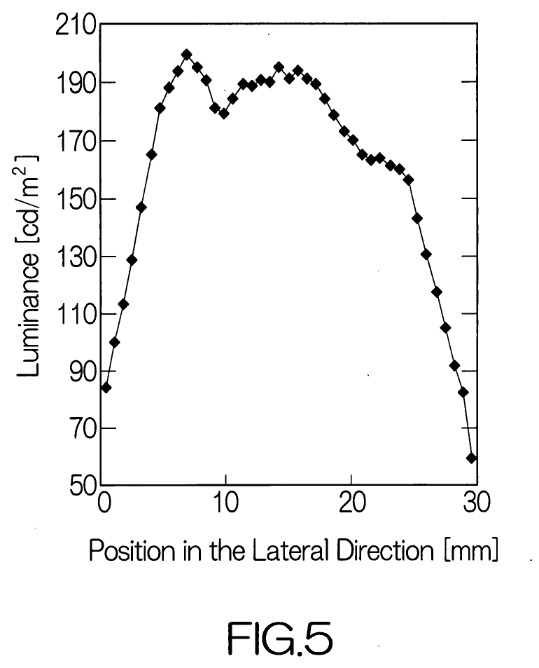

As shown in FIG. 6, a uniform luminance was measured mostly in the lateral direction of the light guiding board 23 in the LCD panel unit 18 according to the example of the invention. Specifically, it has been confirmed that the luminance is prevented from significantly changing depending on a position in the lateral direction of the light guiding board 23. It has also been confirmed that the LCD panel unit 18 is prevented from generation of the dark line according to the example of the invention, though the total amount of the light is decreased as compared with the comparative example. It has also been confirmed that an uneven luminance is prevented across the screen of the LCD panel unit 18. It has also been confirmed that the LCD panel unit 18 is allowed to enjoy a uniform luminance distribution on the screen.

In general, human eyes are insensitive to decrease of the total amount of the light of the LCD panel unit. Unless the LCD panel is visually compared side by side with another one, for example, it is difficult for human to recognize decrease in the amount of the light. Human eyes, however, are sensitive to an uneven luminance generated across the screen of the LCD panel unit. Accordingly, even though the LCD panel unit 18 suffers from a decreased total amount of the light, the uniform luminance serves to provide a good impression on the entire screen of the LCD panel unit.

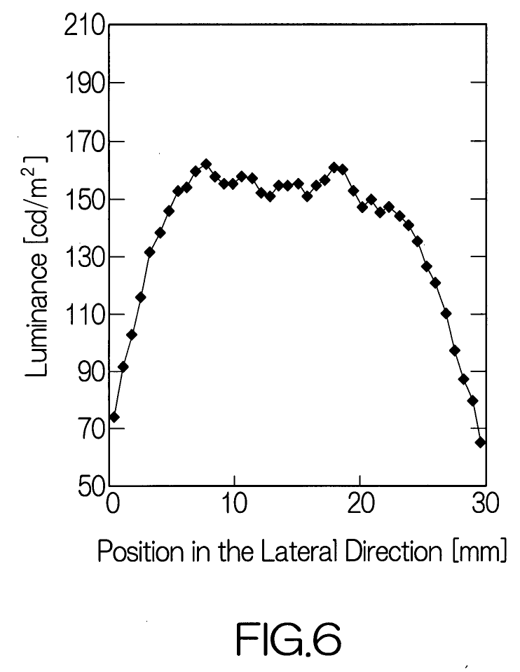

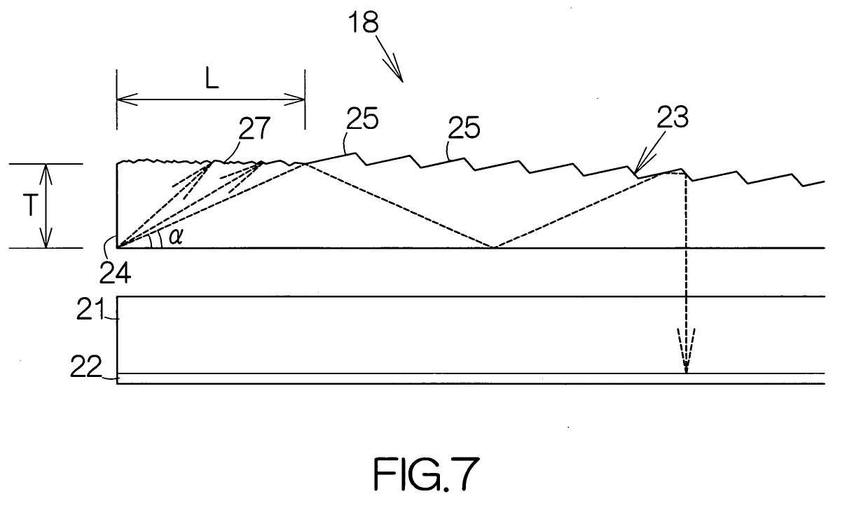

In general, as shown in FIG. 7, as long as light has an incident angle α of 30 degrees or smaller, for example, the prisms 25 serve to effectively direct the light to the surface of the LCD panel 21. Assume that the thickness T of the light guiding board 23 is set at 1, the light scattering structure 27 is expected to have the length L equal to or smaller than the square root of 3 in the perpendicular direction normal to the incidence surface 24. For example, light having an incident angle larger than 30 degrees is thus reliably directed to the linear regions 33 through the light scattering structure 27. It should be noted that the incident angle α is defined as an intersection angle between the light and a horizontal plane parallel to the front or back surface of the light guiding board 23.

As shown in FIG. 8, the light scattering structure 27 of the light guiding board 23 may include parallel curved prisms 34, 34, . . . extending toward the flat regions along curved lines, in place of the polishing marks. The curved lines may be designed to expand toward the prisms 25. The curved line gets closer to the incidence surface 24 at positions closer to the flat regions 26. The curved prisms may take a common shape in each flat region 26.

The curved prisms 34 serve to scatter the light introduced through the incidence surface 24. A part of the scattered light is directed to the linear regions 33 in a relatively facilitated manner. The light of a sufficient amount can be directed to the parallel prisms 25 along the linear regions 33. The LCD panel unit 18 is allowed to enjoy a uniform luminance distribution on the screen. Hereinafter, like reference numerals are attached to the structure or components equivalent to those of the aforementioned embodiment.

A method of making the light guiding board 23 may includes molding a first resin board having the prisms 25 and a second resin board having the curved prisms 34. Separate molds may be prepared for making the first and second resin boards. The first and second resin boards may be bonded to each other afterward. The light guiding board 23 is formed in this manner. It should be noted that the shapes of the curved prisms 34 may be adjusted depending on the amount of light at the linear regions 33.

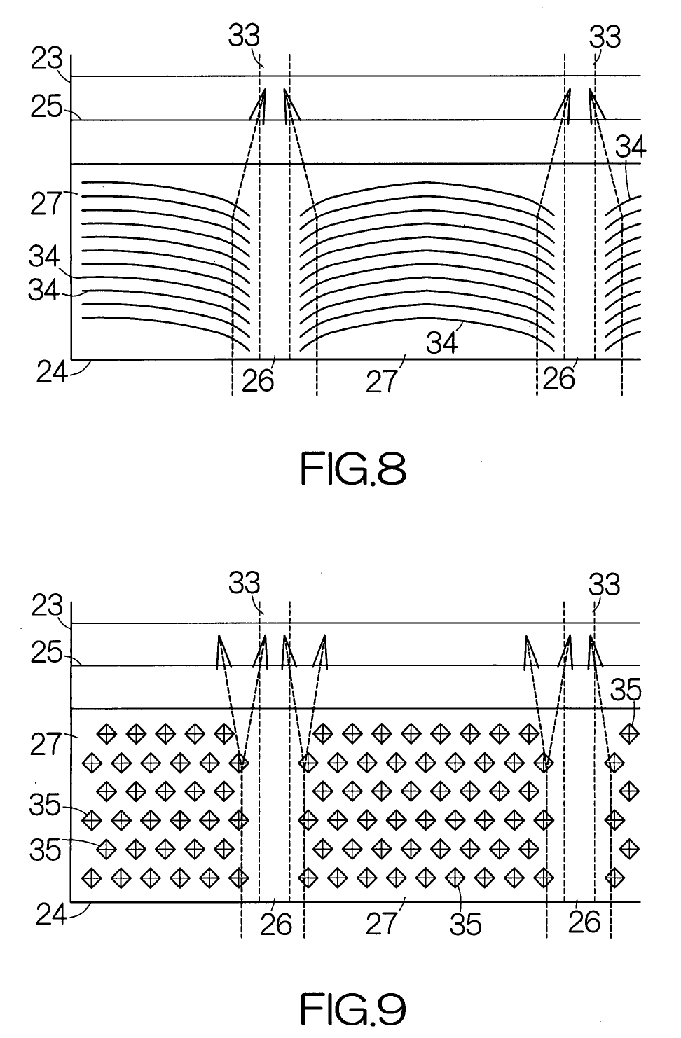

As shown in FIG. 9, the light scattering structure 27 may include protrusions 35, 35, . . . protruding from the surface of the light guiding board 23 in place of the curved prisms 34. The protrusions 35 may be arranged at regular intervals, for example. The protrusion 35 may take the shape of a pyramid having the polygon-shaped bottom, for example. In this case, the protrusions 35 each take the shape of a pyramid having the quadrangular bottom, for example. Boundary surfaces defined between the protrusions 35 and the light guiding board 23 may take a common shape. Since the protrusions 35 each take the shape of a pyramid having the quadrangular bottom, the boundary surfaces each take the shape of a quadrangle.

The protrusions 35 serve to scatter the light introduced through the incidence surface 24 in the light guiding board 23. The light is scattered along the surface of the light guiding board 23. A part of the scattered light is directed to the linear regions 33 in a relatively facilitated manner. The light of a sufficient amount can be directed to the prisms 25 along the linear regions 33. The LCD panel unit 18 is allowed to enjoy a uniform luminance distribution on the screen. The aforementioned method for making the prisms 34 may be employed to make the protrusions 35.

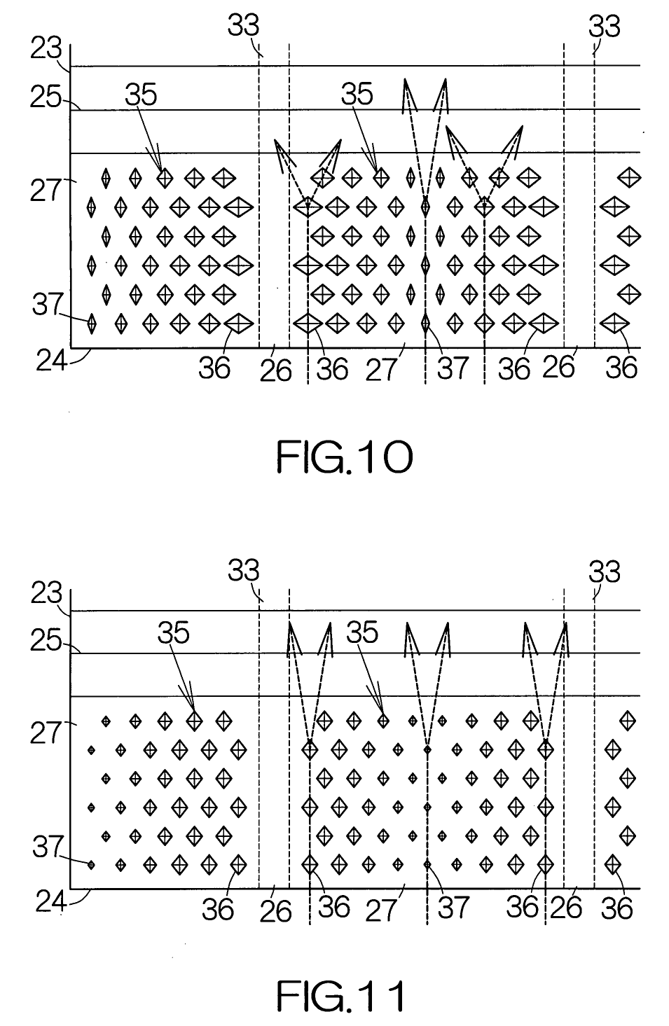

As shown in FIG. 10, the protrusions 35 may include first protrusions 36 and second protrusions 37 in the light scattering structure 27. The first protrusions 36 protrude from the surface of the light guiding board 23 at positions distanced from the flat region 26 by first distances, while the second protrusions 37 protrude from the surface of the light guiding board 23 at positions distanced from the flat region 26 by second distances larger than the first distances. The first protrusions 36 are placed at positions closer to the flat regions 26. Here, the boundary surfaces defined between the first protrusions 36 and the light guiding board 23 are set larger in the direction perpendicularly intersecting the flat regions 26 than the boundary surfaces defined between the second protrusions 37 and the light guiding board 23. The areas of the boundary surfaces of the first protrusions 36 are set larger than the areas of the boundary surfaces of the second protrusions 37. The boundary surfaces may get smaller in the direction perpendicularly intersecting the flat regions 26 as the position shifts from the first protrusions 36 to the second protrusions 37. The area of the boundary surface also get smaller as the position shifts from the first protrusions 36 to the second protrusions 37.

The first and second protrusions 36, 37 serve to scatter the light introduced through the incidence surface 24 in the light guiding board 23. The first protrusions 36 scatter the light widely along the surface of the light guiding board 23 as compared with the light scattered at the second protrusions 37. In addition, the first protrusions 36 are placed at positions distanced from the flat regions 26 by the first distances smaller than the second distances. The first protrusions 36 thus serve to direct a part of the scattered light to the linear regions 33 in a relatively large amount as compared with the light scattered at the second protrusions 37. The LCD panel unit 18 is allowed to enjoy a uniform luminance distribution on the screen. This type of the light guiding board 23 is particularly useful in the case where a relatively larger difference is established in the amount of the light between the linear regions 33 and an area closer to the linear regions 33 outside the linear regions 33, for example.

As shown in FIG. 11, the boundary surfaces defined between the first protrusions 36 and the light guiding board 23 may be set smaller in the direction parallel to the flat regions 26 than the boundary surfaces defined between the second protrusions 37 and the light guiding board 23. The shape of the boundary surfaces between the first protrusions 36 and the light guiding board 23 may be set equal to the shape of the boundary surfaces between the second protrusions 37 and the light guiding board 23, for example. Specifically, the boundary surfaces of the first and second protrusions 36, 37 may take a similar shape. Here, the areas of the boundary surfaces may get smaller as the position shifts from the first protrusions 36 to the second protrusions 37.

Since the boundary surfaces of the first and second protrusions 36, 37 have a similar shape in the light guiding board 23, the light is equally scattered along the surface of the light guiding board 23. Since the area of the boundary surface of the first protrusion 36 is set larger than the area of the boundary surface of the second protrusion 37, a larger amount of light is scattered from the first protrusions 36. In addition, the first protrusions 36 are placed at positions distanced from the flat regions 26 by the first distances smaller than the second distances. The first protrusions 36 thus serve to direct a part of the scattered light to the linear regions 33 in a relatively large amount as compared with the light scattered at the second protrusions 37. The LCD panel unit 18 is thus allowed to enjoy a uniform luminance distribution on the screen in the same manner as described above.

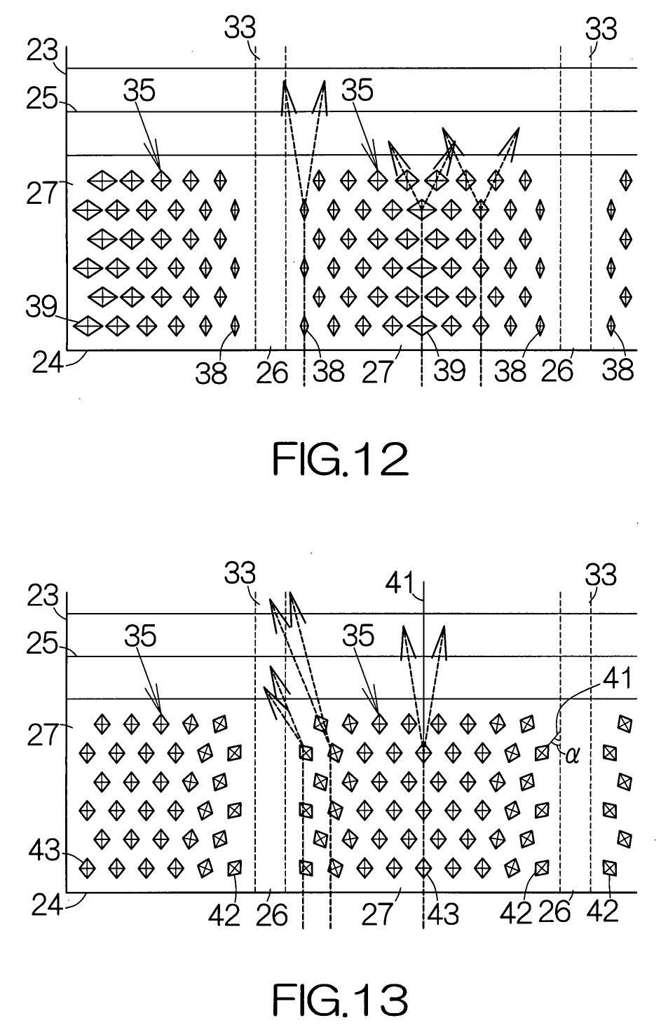

As shown in FIG. 12, the light scattering structure 27 may allow the arrangement of the first and second protrusions 36, 37, opposite to the arrangement shown in FIG. 10. In this case, the boundary surfaces between the first protrusions 38 and the light guiding board 23 may be set smaller in the direction perpendicularly intersecting the flat regions 26 than the boundary surfaces between the second protrusions 39 and the light guiding board 23. The areas of the boundary surfaces of the first protrusions 38 may be set larger than the areas of the boundary surfaces of the second protrusions 39. Here, the boundary surfaces may get larger in the direction perpendicularly intersecting the flat regions 26 as the position shifts from the first protrusions 38 to the second protrusions 39. The areas of the boundary surfaces correspondingly gets larger as the position shifts from the first protrusions 38 to the second protrusions 39.

The first protrusions 38 serve to scatter the light introduced through the incidence surface 24 in the light guiding board 23. The first protrusions 36 scatter the light narrowly along the surface of the light guiding board 23 as compared with the light scattered at the second protrusions 37. The first protrusions 36 are placed at positions distanced from the flat regions 26 by the first distances smaller than the second distances, so that the first protrusions 36 serve to direct a part of the scattered light to the linear regions 33 in a relatively large amount. On the other hand, the second protrusions 39 serve to scatter the light widely along the surface of the light guiding board 23 as compared with the light scattered at the first protrusion 38. Even if the second protrusions 39 are placed at positions distanced from the flat regions 26 by the second distances larger than the first distances, the second protrusions 37 serve to direct a part of the scattered light to the linear regions 33 in a relatively large amount. The LCD panel unit 18 is allowed to enjoy a uniform luminance distribution on the screen. This type of the light guiding board 23 is particularly useful in the case where a relatively larger difference is established in the amount of the light between the linear regions 33 and an area remoter from the linear regions 33 outside the linear regions 33, for example.

As shown in FIG. 13, the intersection angle α between the flat region 26 and a reference line 41 of the first protrusion 42 is set larger than the intersection angle β between the flat region 26 and the reference line 41 of the second protrusion 43 in the light scattering structure 27. The reference line 41 extends across the boundary surface at the individual protrusion 35. The boundary surfaces of the protrusions 35 take a common shape. The reference line 41 is set unique to the shape of the boundary surfaces. Since the boundary surface takes the shape of a quadrangle, the reference line 41 is defined as the diagonal of the quadrangle. Here, the intersection angle β may be set at zero degree for the second protrusions 43. The intersection angle between the reference line 41 and the flat region 26 may gradually get smaller as the position shifts from the first protrusion 42 to the second protrusion 43.

The first and second protrusions 42, 43 serve to scatter the light introduced through the incidence surface 24 in the light guiding board 23. The intersection angle α enables the first protrusions 42 to scatter light widely toward the linear regions 33 along the surface of the light guiding board 23. In addition, the first protrusions 42 are placed at positions distanced from the flat regions 26 by the first distances smaller than the second distances. The first protrusions 42 thus serve to direct a part of the scattered light to the linear regions 33 in a relatively large amount as compared with the light scattered at the second protrusions 43. The LCD panel unit 18 is thus allowed to enjoy a uniform luminance distribution on the screen in the same manner as described above.

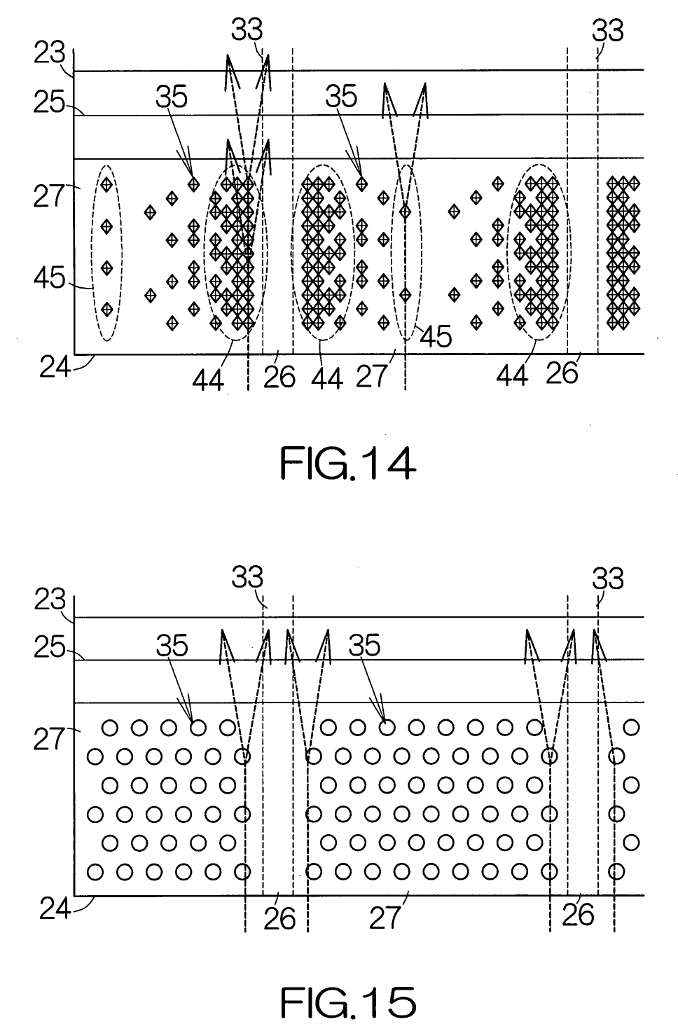

As shown in FIG. 14, the light scattering structure 27 may include a first protrusion group 44 consisting of protrusions 35 at positions distanced from the flat regions 26 by a first distance, and a second protrusion group 45 consisting of the protrusions 35 at positions distanced from the flat regions 26 by a second distance larger than the first distance. The first protrusion group 44 is placed at a position closer to the flat region 26. The protrusions 35 are arranged more tightly in the first protrusion group 44 than the protrusions 35 in the second protrusion group 45. Specifically, the first protrusion group 44 includes the protrusions 35 at a higher density as compared with the protrusions 35 in the second protrusion group 45. In this case, the boundary surfaces of the protrusions 35 of the first and second protrusion group 44, 45 may take a common shape.

The light is equally scattered along the surface of the light guiding board 23 at the protrusions 35 in the first and second protrusion groups 44, 45. Since the protrusions 35 are arranged more tightly in the first protrusion group 44 than the protrusions 35 in the second protrusion group 45, the first protrusion group 44 serves to scatter the light of a relatively large amount as compared with the second protrusion group 45. In addition, the first protrusion group 44 is placed at a position distanced from the flat region 26 by the first distance smaller than the second distance. The first protrusion group 44 thus serves to direct a part of the scattered light to the linear regions 33 in a relatively large amount as compared with the light scattered at the second protrusions 37. The LCD panel unit 18 is thus allowed to enjoy a uniform luminance distribution on the screen in the same manner as described above.

As shown in FIG. 15, the protrusions 35 may take a semispherical shape protruding from the surface of the light guiding board 23, for example. The protrusions 35 may be arranged at regular intervals, f or example, in the same manner as described above. The boundary surfaces between the protrusions 35 and the light guiding board 23 may take a common shape. The light guiding structure 27 serves to scatter the light introduced through the incidence surface 24. The light is scattered along the surface of the light guiding board 23. The scattered light is partly directed to the linear regions 33 in a relatively facilitated manner. The LCD panel unit 18 is thus allowed to enjoy a uniform luminance distribution on the screen.

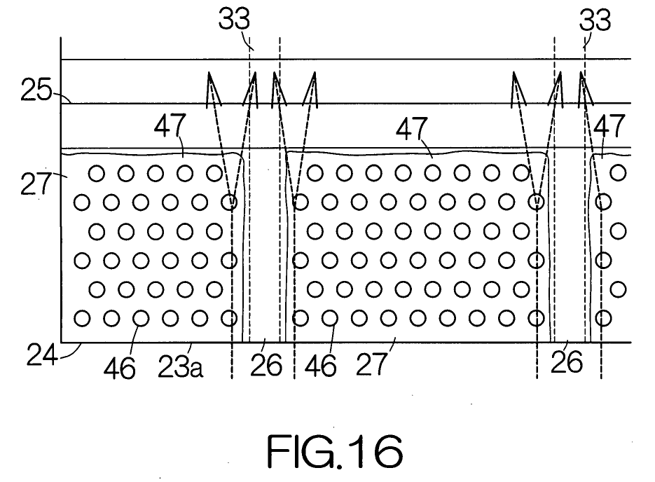

As shown in FIG. 16, a light guiding board 23a may include balls 46 arranged in a space between the incidence surface 24 and the parallel prisms 25 in place of the light scattering structure 27. The balls 46 are arranged at position off the flat regions 26. The balls 46 may be made of metal balls each having a mirror surface, for example. An adhesive 47 made of resin may be utilized to fix the balls 46 on the surface of the light guiding board 23a, for example. The balls 46 serve to scatter the light introduced through the incidence surface 24. The LCD panel unit 18 is thus allowed to enjoy a uniform luminance distribution on the screen in the same manner as described above.

The light guiding board 23a may include first balls arranged at positions distanced from the flat regions 26 by first distances, and second balls arranged on the surface of the light guiding board 23a at positions distanced from the flat regions 26 by second distances larger than the first distances. The first balls may be set larger in size than the second balls, for example. The size of the balls 46 may gradually get smaller as the position shifts from the first balls to the second balls. The light guiding board 23a may include a first ball group consisting of the balls 46 at positions distanced from the flat region 26 by first distances, and a second ball group consisting of the balls 46 at positions distanced from the flat region 26 by second distances larger than the first distances. Specifically, the balls 46 may be arranged more tightly in the first ball group than the balls in the second ball group.

The light guiding structure 27 and the balls 46 may be placed on the back surfaces of the light guiding boards 23, 23a, for example. The LCD panel unit 18 can be incorporated in electronic apparatus other than the cellular phone terminal 11, such as a personal digital assistant (PDA), a digital camera and a personal computer. The light guiding boards 23, 23a can be incorporated in the LCD panel unit of a so-called back light type, other than the LCD panel unit of the front light type.

What is claimed is:

1. A light guiding board comprising:
an incidence surface defined in an end surface of an optically-transparent board member;
parallel prisms formed on a surface of the optically-transparent board member at a position distanced from the incidence surface;
a flat region defined along a straight line in the surface of the optically-transparent board member between the incidence surface and the parallel prisms; and
a light scattering structure placed between the incidence surface and the parallel prisms, the light scattering structure formed on the surface of the optically-transparent board member at a position off the flat region, the light scattering structure having a boundary surface designed to scatter light.

2. The light guiding board according to claim 1, wherein the light scattering structure includes a polishing mark.

3. The light guiding board according to claim 1, wherein the light scattering structure includes a curved prism designed to extend toward the flat region along a curved line.

4. The light guiding board according to claim 1, wherein the light scattering structure includes a protrusion protruding from the surface of the optically-transparent board member.

5. The light guiding board according to claim 1, wherein the light scattering structure includes:
a first protrusion protruding from the surface of the optically-transparent board member at a position distanced from the flat region by a first distance; and
a second protrusion protruding from the surface of the optically-transparent board member at a position distanced from the flat region by a second distance larger than the first distance, wherein
a boundary surface defined between the first protrusion and the optically-transparent board member is set larger in a direction perpendicularly intersecting the straight line than a boundary surface defined between the second protrusion and the optically-transparent board member.

6. The light guiding board according to claim 1, wherein the light scattering structure includes:
a first protrusion protruding from the surface of the optically-transparent board member at a position distanced from the flat region by a first distance; and
a second protrusion protruding from the surface of the optically-transparent board member at a position distanced from the flat region by a second distance larger than the first distance, wherein
a boundary surface defined between the first protrusion and the optically-transparent board member is set smaller in a direction perpendicular to the straight line than a boundary surface defined between the second protrusion and the optically-transparent board member.

7. The light guiding board according to claim 1, wherein the light scattering structure includes:
a first protrusion protruding from the surface of the optically-transparent board member at a position distanced from the flat region by a first distance; and
a second protrusion protruding from the surface of the optically-transparent board member at a position distanced from the flat region by a second distance larger than the first distance, wherein
an area of a boundary surface defined between the optically-transparent board member and the first protrusion is set larger than an area of a boundary surface defined between the optically-transparent board member and the second protrusion.

8. The light guiding board according to claim 1, wherein the light scattering structure includes:
a first protrusion protruding from the surface of the optically-transparent board member at a position distanced from the flat region by a first distance; and
a second protrusion protruding from the surface of the optically-transparent board member at a position distanced from the flat region by a second distance larger than the first distance, wherein
an area of a boundary surface defined between the optically-transparent board member and the first protrusion is set smaller than an area of a boundary surface defined between the optically-transparent board member and the second protrusion.

9. The light guiding board according to claim 1, wherein the light scattering structure includes:
a first protrusion protruding from the surface of the optically-transparent board member at a position distanced from the flat region by a first distance; and
a second protrusion protruding from the surface of the optically-transparent board member at a position distanced from the flat region by a second distance larger than the first distance, wherein
a shape of a boundary surface defined between the second protrusion and the optically-transparent board member is set identical to a shape of a boundary surface defined between the first protrusion and the optically-transparent board member, the first and second protrusions each defining a reference line extending within the boundary surface, the reference line being unique to the shape of the boundary surfaces, an intersection angle between the reference line of the first protrusion and the straight line is set larger than an intersection angle between the reference line of the second protrusion and the straight line.

10. The light guiding board according to claim 1, wherein the light scattering structure includes:
a first protrusion group consisting of protrusions protruding from the surface of the optically-transparent board member at a position distanced from the flat region by a first distance; and
a second protrusion group consisting of protrusions protruding from the surface of the optically-transparent board member at a position distanced from the flat region by a second distance larger than the first distance, wherein
the protrusions of the first protrusion group are arranged at a higher density than the protrusions of the second protrusion group.

11. A light guiding board comprising:
an incidence surface defined in an end surface of an optically-transparent board member;
parallel prisms formed on a surface of the optically-transparent board member at a position distanced from the incidence surface;
a flat region defined along a straight line in the surface of the optically-transparent board member between the incidence surface and the parallel prisms; and
spherical members placed on the surface of the optically-transparent board member between the incidence surface and the parallel prisms at positions off the flat region so as to scatter light.

12. A light source unit comprising:
a light source;
a light guiding member designed to reflect light emitted from the light source so as to irradiate the light from an output surface defined on the light guiding member;
an optically-transparent board member opposed to the light guiding member;
an incidence surface defined in an end surface of the optically-transparent board member, the incidence surface opposed to the output surface of the light guiding member;
parallel prisms formed on a surface of the optically-transparent board member at a position distanced from the incidence surface so as to reflect the light output from the light guiding member;
a flat region defined along a straight line in the surface of the optically-transparent board member between the incidence surface and the parallel prisms; and
a light scattering structure formed on the surface of the optically-transparent board member between the incidence surface and the parallel prisms at a position of f the flat region, the light scattering structure having a boundary surface designed to scatter light.

13. A display panel unit comprising:
a light source;
a light guiding member designed to reflect light emitted from the light source so as to irradiate the light from an output surface defined on the light guiding member;
an optically-transparent board member opposed to the light guiding member;
an incidence surface defined in an end surface of the optically-transparent board member, the incidence surface opposed to the output surface of the light guiding member;
parallel prisms formed on a surface of the optically-transparent board member at a position distanced from the incidence surface so as to reflect the light output from the light guiding member;
a flat region defined along a straight line in the surface of the optically-transparent board member between the incidence surface and the parallel prisms;
a light scattering structure formed on the surface of the optically-transparent board member between the incidence surface and the parallel prisms at a position of f the flat region, the light scattering structure having a boundary surface designed to scatter light; and
a display panel opposed to the surface of the optically-transparent board member.

14. An electronic apparatus comprising:
an enclosure;
a light source incorporated in the enclosure;
a light guiding member designed to reflect light emitted from the light source so as to irradiate the light from an output surface defined on the light guiding member;
an optically-transparent board member opposed to the light guiding member;
an incidence surface defined in an end surface of the optically-transparent board member, the incidence surface opposed to the output surface of the light guiding member;
parallel prisms formed on a surface of the optically-transparent board member at a position distanced from the incidence surface so as to reflect the light output from the light guiding member;
a flat region defined along a straight line in the surface of the optically-transparent board member between the incidence surface and the parallel prisms;
a light scattering structure formed on the surface of the optically-transparent board member between the incidence surface and the parallel prisms at a position off the flat region, the light scattering structure having a boundary surface designed to scatter light; and
a display panel opposed to the surface of the optically-transparent board member, the display panel exposed in an opening defined in the enclosure.
